(19) United States
(12) Patent Application Publication
(10) Pub. No.: US 2012/0186831 A1
(43) Pub. Date: Jul. 26, 2012

(54) DISCHARGE OF FIRE EXTINGUISHING AGENT

(75) Inventors: Greg Simpson, Goleta, CA (US); Bill Elliott, Santa Barbara, CA (US); Steve Hodges, Santa Barbara, CA (US); Robert Dunster, Burnham (GB); Adam Chattaway, Moormede (GB); Simon Davies, Leacroft (GB)

(73) Assignee: Kidde IP Holdings Limited, Colnbrook (GB)

(21) Appl. No.: 13/337,831

(22) Filed: Dec. 27, 2011

Related U.S. Application Data
(62) Division of application No. 10/895,729, filed on Jul. 21, 2004, now abandoned.

(51) Int. Cl. A62C 35/02; A62C 5/00; A62C 37/36

(52) U.S. Cl. 169/27; 169/60

(57) ABSTRACT

Apparatus for rapid discharge of one or more fire extinguishing agent(s). The apparatus includes a sealed container forming an interior volume in communication with a rapidly opening valve assembly. The interior volume contains fire extinguishing agent(s), super-pressurised by a gas such as nitrogen. A portion of the nitrogen is dissolved into the fire extinguishing agent(s). When an incident is detected which requires the discharge of the fire extinguishing agent(s) the valve is opened. Opening the valve causes rapid dissolution of the nitrogen from the fire extinguishing agent(s), forming a two-phase mixture (like a foam or mousse) which substantially fills the volume and causing the discharge of fire extinguishing agent(s) from the valve assembly.

### CROSS REFERENCE TO RELATED APPLICATIONS

This application is a divisional of U.S. application Ser. No. 10/895,729 that was filed with the United States Patent and Trademark Office on Jul. 21, 2004. The entire disclosure of U.S. application Ser. No. 10/895,729 is incorporated herein by reference.

### BACKGROUND OF THE INVENTION

This invention relates to a method of and apparatus for the discharge of one or more fire extinguishing agent(s). It is particularly suited to the rapid discharge of fire extinguishing agent(s) into a restricted space such as the crew bay of a military ground combat vehicle.

The rapid discharge of a fire extinguishing agent into a military ground combat vehicle subsequent to an incident such as a fuel explosion is known to suppress the adverse effects experienced by the personnel within the crew bay of the vehicle to survivable levels. Some of the criteria used to determine a survivable event include extinguishing the flame and preventing re-flashing; a reduction in temperature to prevent greater than second degree burns; and the realisation of safe levels (i.e. levels up to which personnel can continue to carry out their duties) of overpressure, acid gas, oxygen and concentration of fire extinguishing agent within the crew bay.

Further, a typical specification for a military ground combat vehicle requires the system for discharging a fire extinguishing agent to operate successfully at extreme conditions of tilt, roll and temperature. For example, the United States military quote the extremes as equivalent to 31° (60%) fore and aft tilt and ±16.7%° (±30%) sideways roll. The system must also fully operate at temperatures from −32° to +60° C. (and be storable at temperatures from −52° to 72° C.).

A known apparatus for fire extinguishing in such circumstances comprises a generally cylindrical canister which contains a fire extinguishing agent which is pressurised by a gas such as nitrogen. Because the fire extinguishant agent must be applied rapidly, it has been considered essential in the prior art for the canister to be oriented with its longitudinal axis extending vertically so that the extinguishing agent lies at the bottom of the cylinder (because it is denser than the pressurising fluid). The outlet for the extinguishant from the canister is positioned at the base of the cylinder. A valve is operated to allow the discharge of the extinguishing agent. The opening of the valve allows the nitrogen to expand, pushing the extinguishant between it and the valve out through the valve. The vertical orientation of the cylinder and the location of the outlet at the base of the cylinder have been considered essential in the prior art in order to allow a high proportion of the extinguishing agent to be discharged rapidly (because the extinguishing agent will be pushed out of the outlet by the nitrogen lying above the extinguishing agent).

The requirement to orientate the cylinder vertically reduces the flexibility with which the cylinders can be positioned. Also, because the cylinders are used in restricted spaces (such as relatively small military vehicles), to provide the desired spread of extinguishing agent and to prevent the extinguishing agent being applied too close to personnel or equipment (which can be harmful), it is often required for the outlet nozzle for the extinguishing agent to be located as high as possible—typically almost at roof or ceiling height. This requires a hose or conduit to extend upwards from the outlet at the base of the cylinder so that the nozzle at the end of this hose or conduit is provided at the required height.

Such a prior art arrangement is described in more detail below.

### SUMMARY OF THE INVENTION

According to a first aspect of the invention there is provided fire extinguishing or suppressing apparatus comprising a vessel containing a fire extinguishing agent and a fluid, stored under pressure, and means for selectively discharging the fire extinguishing agent by opening an outlet in the vessel, the arrangement being such that the opening of the outlet causes the formation of a two phase mixture in the vessel which is a primary mechanism for discharging the fire extinguishant from the vessel.

According to a second aspect of the invention there is provided fire extinguishing or suppressing apparatus comprising a vessel containing a fire extinguishing agent and a fluid, stored under pressure, such that a portion of fluid is dissolved in the fire extinguishing agent, and means for selectively opening an outlet of said vessel to discharge the fire extinguishing agent, the arrangement being such that the principal mechanism for discharging the fire extinguishing agent is the dissolution of the fluid from the fire extinguishing agent in response to the opening of the outlet.

The invention also relates to use of a fire extinguishing agent and a fluid stored under pressure in a vessel having a selectively openable outlet for forming a two-phase mixture in response to opening of the outlet, whereby the fire extinguishant is discharged from the vessel.

According to a fourth aspect of the invention there is provided a method of discharging a fire extinguishing agent from a vessel having a selectively openable outlet and containing the fire extinguishing agent stored under pressure with a fluid, the method including opening a valve to cause the rapid dissolution of the fluid from the fire extinguishant such that a two-phase mixture is formed within the vessel which causes the discharge of the fire extinguishing agent from the vessel through the outlet.

According to a fifth aspect of the invention there is provided a method of providing a fire extinguishing or suppressing apparatus, the method including providing a fire extinguishing agent and a fluid under pressure in a container such that a portion of the fluid dissolves into the fire extinguishing agent, the portion being sufficient to create a two-phase mixture by dissolution of the fluid from the fire extinguishing agent when the vessel is de-pressurised for providing a primary mechanism for expelling the fire extinguishant from the vessel through an outlet thereof.

According to a sixth aspect of the invention there is provided apparatus for deploying a fire extinguishing, fire suppressing or acid scavenging powder for use with a fire extinguishing or suppressing device which discharges a fire extinguishing or suppressing agent in response to detection of an incident, the apparatus including a vessel in which said powder is stored and having a barrier or membrane which, in use, is ruptured or broken as the fire extinguishing agent is discharged from the device such that the powder is discharged from the vessel.

### BRIEF DESCRIPTION OF THE DRAWINGS

A method of and apparatus for the discharge of a fire extinguishing agent will now be described by way of example only and with reference to the accompanying drawings, in which:

FIG. 1 is a perspective view of prior art apparatus for the discharge of an fire extinguishing agent;

FIG. 1A is a simplified cross-section of the apparatus of FIG. 1;

FIG. 2 is a front elevational view representation of a first embodiment of apparatus for the rapid discharge of a fire extinguishing agent in accordance with the present invention;

FIG. 3 is an end-on view of the apparatus of FIG. 2;

FIG. 4 is a cross section along the line A-A of FIG. 3;

FIG. 5 is a cross section along the line B-B of FIG. 2;

FIGS. 6A to 6D show the formation of a two-phase mixture in a pressurised container;

FIG. 7 is a representation of a second embodiment of apparatus for the rapid discharge of a fire extinguishing agent in accordance with the present invention; and

FIG. 8 is a cross-sectional view similar to FIG. 4 and showing different arrangements for discharging a powder suppressant.

In the drawings, like elements are generally designated with the same reference numeral.

### DETAILED DESCRIPTION OF EMBODIMENTS OF THE INVENTION

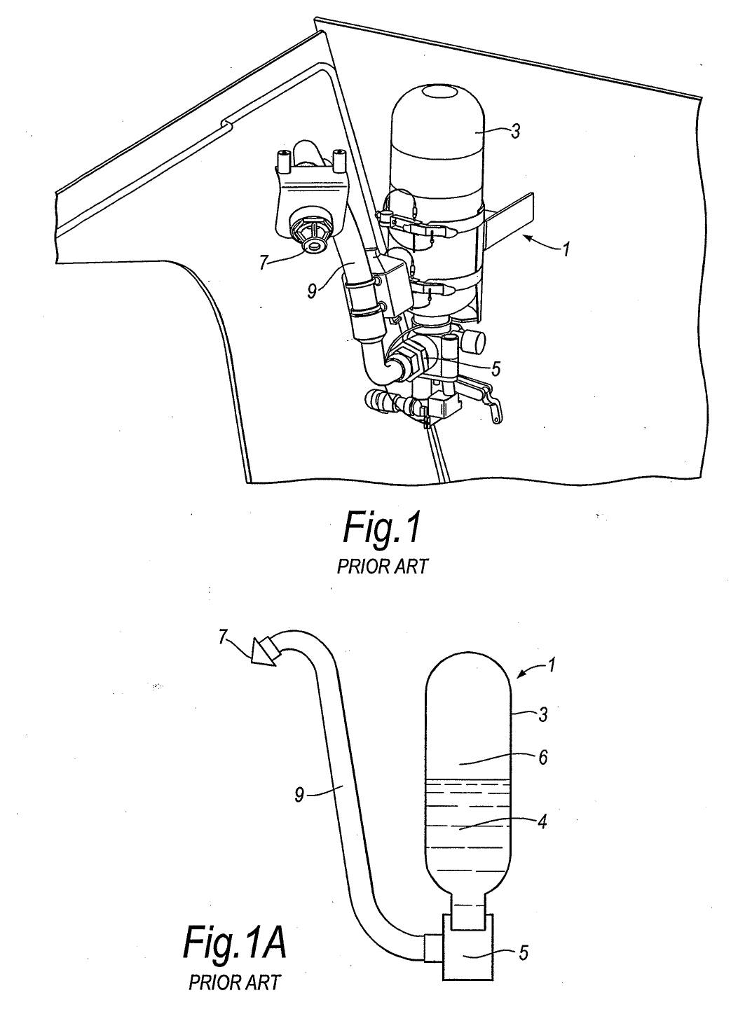

A known apparatus for the discharge of a fire extinguishing agent is shown in FIGS. 1 and 1A. This apparatus 1 comprises a generally cylindrical steel canister 3 and a releasing mechanism 5, such as a valve assembly—including valve 30. The releasing mechanism 5 may be opened by a solenoid actuator, a metron actuator or any other suitable form of actuator. A predetermined mass of fire extinguishing agent 4 is added to the canister 3 which is then super-pressurised with nitrogen 6 to around 50 to 60 bar(g).

When the releasing mechanism 5 is opened the fire extinguishing agent 4 typically discharges from the canister 3 in a fraction of a second. The canister 3 is usually fitted vertically (that is with its longitudinal axis extending vertically), or as close to vertical as possible, within the crew bay of a military ground combat vehicle. In order for the fire extinguishing agent to be distributed homogenously within the vehicle crew bay without adversely impacting the personnel or equipment contained therein, an outlet nozzle 7 needs to be extended to the ceiling of the crew bay, where the walls meet the roof This is achieved in the apparatus 1 of FIG. 1 by connecting the nozzle 7 to the releasing mechanism 5 via an appropriate length of hose or pipe 9.

As briefly discussed above, the vertical orientation of the canister 3 has been considered essential in the prior art because this allows the releasing mechanism 5 at the outlet of the canister 3 to be located at the lowest point. The fire extinguishant 4 lies at the base of the canister 3 (due to its relatively high density), with the nitrogen 6 pressurising the space above. Such an arrangement was thought essential for the rapid discharge of a high proportion of the extinguishant. It was understood that, when the releasing mechanism 5 was opened, the nitrogen 6 would expand and rapidly force the extinguishant 4 through the valve, along the hose 9 and out of the nozzle 7. It was thought that if the canister was not mounted substantially vertically within the crew bay (or other chamber) any significant inclination of the crew bay chamber would result in significant quantities of extinguishant 4 not being expelled by the expansion of the nitrogen because some extinguishant would not lie in the path between the nitrogen and the valve.

While achieving the desired distribution pattern for the fire extinguishing agent within the crew bay of the vehicle, adding a hose 9 to the apparatus 1 has been shown to be detrimental to the delivery rate of the fire extinguishing agent and therefore detrimental to suppression performance. The extra volume created between the cylinder 3 and the nozzle 7 causes an increase in the time taken for the fire extinguishing agent to initially arrive at the nozzle 7 and a lower nozzle pressure, which reduces the delivery rate of fire extinguishing agent relative to a nozzle assembly 7 fixed directly onto the releasing mechanism 5.

Despite these disadvantages, such prior art arrangements have been persisted with because it was considered essential for the canister to be oriented vertically and for the outlet of the canister 3 to be located at or near the lowest point, which is where the pressurised extinguishant is located.

When the fire extinguishing agent 4 is super-pressurised by nitrogen 6 within the canister, a proportion of the nitrogen 6 dissolves into the fire extinguishant. When the valve is operated to deploy the fire extinguishant agent, the rapid expansion of gas dissolved within the fire extinguishing agent causes turbulence within the canister, which forms a two phase mixture of liquid extinguishing agent and nitrogen—a foam or mousse is formed. Although such a two phase mixture may have been formed in the prior art, this was not thought to contribute to the expulsion of the extinguishing agent and was thought, if anything, to be a disadvantageous but unavoidable consequence of storing the fire extinguishing agent in super-pressurised conditions.

The present inventors have observed that the creation of the two-phase mixture of liquid and gas occurs very quickly when the releasing mechanism is opened, and the two-phase mixture will rapidly fill the interior volume of the canister. In the embodiments to be described, the two-phase mixture is used as a principal or primary mechanism to discharge the extinguishing agent. When it is realised that the extinguishing agent can be expelled due to the rapid formation of the two-phase mixture, there is considerably more flexibility in the configuration and orientation of the extinguishing apparatus. The present inventors have determined that it is in fact not necessary to have the outlet of the canister at the base with a substantial depth of extinguishant above. The rapid formation of the two-phase mixture which fills the canister can be used, in accordance with the invention, to expel the extinguishing agent wherever the outlet is positioned in the canister.

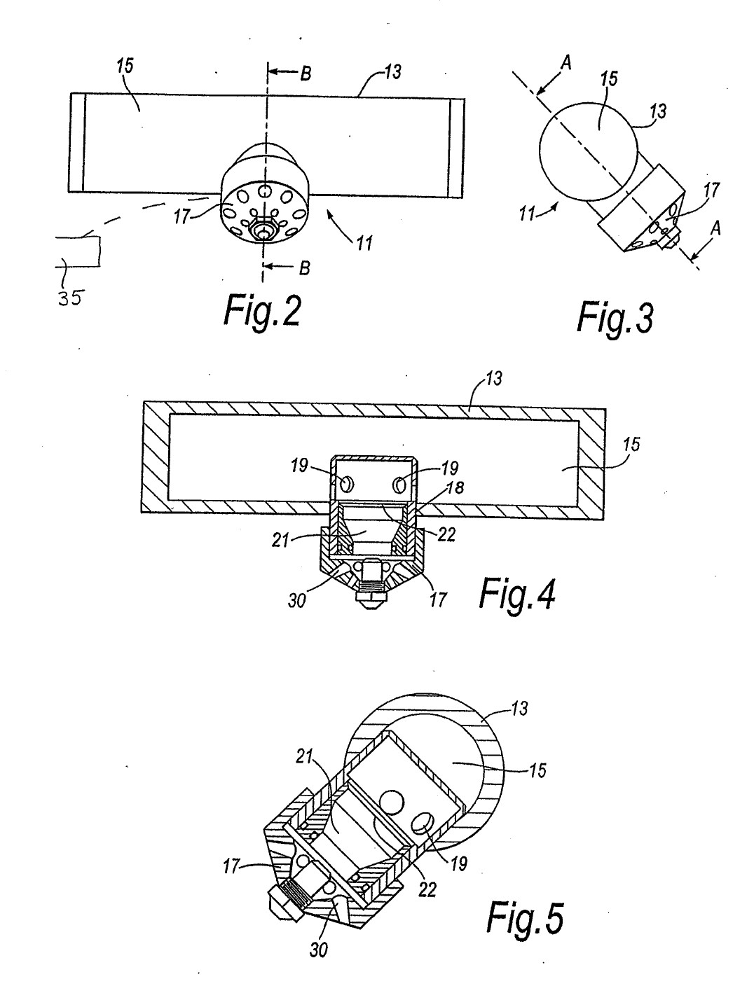

Apparatus for the rapid discharge of a fire extinguishing agent in accordance with the present invention is shown in FIGS. 2 to 6.

FIG. 2 shows such apparatus 11 comprising a sealed canister 13 forming an interior volume 15 in communication with a rapidly opening releasing member 17, such as a valve assembly 17. (The releasing member 17 preferentially does not protrude too far from the canister 13, thus producing a low profile apparatus 11). FIG. 3 is an end-on view of the apparatus of FIG. 2, FIG. 4 is a cross-section of FIG. 2 along the line A-A of FIG. 3, and FIG. 5 is a cross-section of FIG. 2 along the line B-B of FIG. 2. FIGS. 4 and 5 show in more detail how the releasing member 17 is in communication with the interior volume 15 of the canister 13 through an outlet 18. The fluid communication between the releasing member 17 and the interior volume may be via optional holes 19 or by any other suitable means. A releasing member 17 actuator (not shown) is designed to operate within 5 ms of an incident, with a safe level of fragmentation of the releasing member 17. The releasing member 17 actuator may comprise a solenoid actuator, an electric protractor actuator, a metron actuator or any other suitable form of actuator.

The apparatus will, in use, be mounted in a chamber—such as (but not limited to) the crew bay of a vehicle—where explosion suppression is required.

Typically, the chamber or crew bay will lie or be supported on a generally flat horizontal surface. The walls of the chamber or crew bay will therefore be generally vertical and the roof or ceiling will be generally horizontal, parallel to the floor.

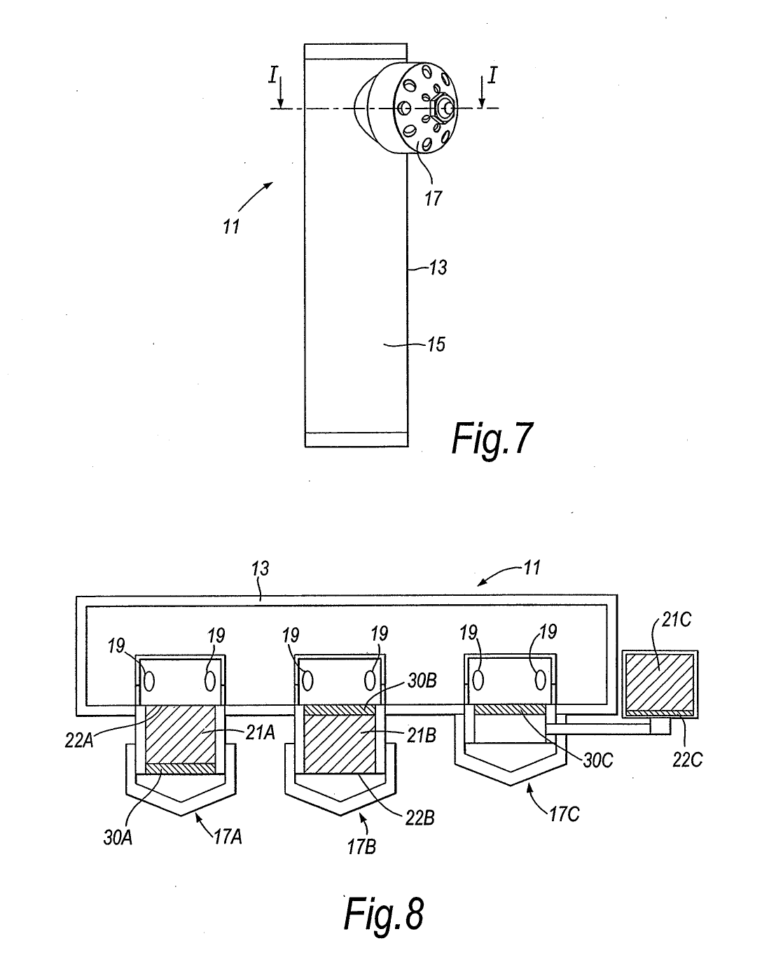

In FIG. 2, the releasing member 17 is located at the mid-point of the canister 13 and the releasing member 17 is oriented at 45° to both the horizontal and the vertical, but other arrangements could alternatively be used. For example the releasing member 17 could be located at one end of the canister 13 (as shown in FIG. 7), or the canister 13 could comprise a plurality of releasing member 17 along its length (as shown in FIG. 8). In use the canister 13 of FIG. 2 could be mounted horizontally (that is with its longitudinal axis extending horizontally), adjacent to the ceiling of the chamber or crew bay, and preferentially positioned where the ceiling meets the wall with the releasing member 17 oriented at 45° to both the ceiling and the wall.

Alternatively, apparatus 11 with the releasing member 17 located at one end of the canister 13 (as shown in FIG. 7) could be mounted vertically so that the releasing member 17 is located adjacent to the ceiling of the crew bay. With either horizontal or vertical orientation, the apparatus shown in FIG. 7 could be arranged so that the releasing member 17 is positioned in the upper corners of the crew bay.

Several of the apparatus 11 could be mounted within the crew bay. Generally, the number and position of the apparatus 11 is selected to provide a rapid and even distribution of fire extinguishant when required.

The apparatus 11 is designed to be compatible with existing detection systems (such as an Automatic Fire Extinguishing System, AFES) for actuating the releasing member 17 to allow the rapid discharge of the fire extinguishing agent subsequent to an incident such as an explosion. Such detection systems may, for example, detect infra-red radiation, and may be able to detect an explosion within 2 ms of it occurring. The detection system 35 shown generically in FIG. 2 signals the actuator to operate the releasing member. The detection system may comprise a single IR-sensor, a dual IR sensor (e.g. a Dual Spectrum (RTM) Sensor), a UV sensor, or UV and IR sensors.

The outlet diameter of the releasing member 17 may advantageously be smaller than the outlet diameter of known apparatus. This reduction in outlet size advantageously reduces the impact force on personnel in the crew bay. Also, the interior volume 15 of the canister 13 may be smaller than for known apparatus, which may mean that more canisters 13 are required in a given crew bay to provide the necessary performance. Table 1 shows a comparison of known apparatus with prototypical apparatus according to the present invention, in which the outlet diameter of the releasing member 17 is 25 mm, in terms of canister volume and outlet size.

TABLE 1

| | | | | | | Ratio of |
|---|---|---|---|---|---|---|
| | | | | Single | Combined | Outlet Area |
| | Number | Combined | Outlet | Outlet | Outlet | to that of |
| | and Size of | Canister | Diameter | Area | Area | Solenoid |
| Apparatus | Canisters | Volume (L) | (mm) | (mm²) | (mm²) | Actuator |
| Known type, | 2 × 4 L | 8 | 30 | 706.9 | 1413.7 | 1 |
| solenoid actuator | | | | | | |
| Known type, | 2 × 4 L | 8 | 32 | 804.3 | 1608.5 | 1.14 |
| electric actuator | | | | | | |
| Prototype | 6 × 1 L | 6 | 25 | 490.9 | 2945.2 | 2.08 |

Table 1 shows that, when a greater number of smaller canisters 13 are used within the vehicle, the combined outlet area can be approximately double that of known apparatus. This allows the fire extinguishing agent to be discharged more rapidly to the interior of the crew bay. Additionally, as more canisters 13 are used, the fire extinguishing agent can be advantageously delivered from more locations within the crew bay to provide a more effective distribution of the fire extinguishing agent. Also, typically the distance from the nearest nozzle to the fire is reduced.

The design of future military combat vehicles is based on the requirement of lightweight and highly manoeuvrable vehicles, and apparatus for the rapid discharge of fire extinguishing agent into the crew and mission bays of future combat vehicles is thus also required to be lightweight. This requirement is realised by the design of apparatus such as that according to the embodiments of present invention. The known crew bay suppressor canisters are manufactured using mild steel cylinders. In contrast, in the embodiments the canister is relatively thin walled and manufactured from a material with a high strength to weight ratio, which could be a steel (stainless or carbon), alloy steel or alloy such as aluminium, nickel, titanium, magnesium or a combination of the above. Composite materials may also be used. Weight may be further reduced by integrating the release mechanism into the suppressor module. This simpler design will reduce the weight of a module compared to a conventional solenoid actuator. Further, the basic geometry of the apparatus 11 and flexibility with which it can be mounted, places the discharge of extinguishant high in the vehicle where it needs to be. A significant system weight saving occurs here as the apparatus 11 does not require hoses and related mounting brackets as shown in FIG. 1 and FIG. 1A.

To prepare the apparatus 11 for operation, the interior volume 15 of the canister 13 is filled with a predetermined mass of gaseous fire extinguishing agent, which is then super-pressurised with a gas. The gas used is preferentially nitrogen, but any other suitable fluid could be used. The fire extinguishing agent is preferentially pressurised to a pressure within the range of 50 bar(g) to 60 bar(g). Known fire extinguishing agents, for example a hydrofluorocarbon such as HFC 227ea (e.g. FM200 (RTM)) manufactured by Great Lakes Chemical or HFC236fa (e.g. FE36 (RTM)) manufactured by DuPont, or a perfluoroketone such as Novec (RTM) 1230 manufactured by 3M may be used, but the apparatus is suitable for use with any fire extinguishing agent which allows substantial volumes of the gas to dissolve into it (i.e. any fire extinguishing agent possessing a small value for the Henry's law constant). For example, the mass of nitrogen which is able to dissolve into 1 litre of fire extinguishing agent, in a canister with a volume of 2 litres at a temperature of 20° C. and a pressure of 60 bar(g), is shown in Table 2 for the fire extinguishing agents water, FM200 and Novec 1230.

TABLE 2

| | Mass of | Mass of N₂ | | |
|---|---|---|---|---|
| Extinguishing | Agent | Total | Liquid Phase | Headspace |
| Agent | (kg) | (g) | (g) | (g) |
| Water | 1 | 75 | 0.11 | 74.89 |
| FM200 | 1.43 | 100 | 41 | 59 |
| Novec 1230 | 1.6 | 100 | 35 | 65 |

As an alternative to the extinguishing agents described above, other halocarbon extinguishing agents containing chemicals such as Bromine, Iodine or Chlorine may be used. Although the extinguishing agent is described as a gaseous agent, and this term is used by the fire industry to define these types of agents, it may not be quite accurate. A gaseous agent implies that all the agent mixes within a chamber as a gas. There are some extinguishing agents such as PFC 614 (a perflurocarbon) that would exit a pipe type extinguisher, because plenty of nitrogen dissolves into the liquid phase, but may remain as a liquid within the vehicle crew bay as the boiling point is 56° C. Testing has shown that streaming agents such as this can still be considered for crew bay applications, but careful consideration is required for nozzle location and extinguishing concentration hold times within a vehicle. An alternative to gaseous extinguishing agents could therefore be extinguishing fluids.

As an alternative to (or in addition to) nitrogen, the pressurising gas may comprise any other inert gases, such as Argon or Argonite (RTM), and may also include air. The apparatus 11 could be used to reduce the oxygen levels within a vehicle to a specific volume %. An inert gas/air mixture could be used as a mechanism to control this level.

An important factor for the effective performance of apparatus 11 in terms of suppressing the adverse effects experienced by the personnel within the crew bay of the vehicle is the dissolving of the gas into the fire extinguishing agent to form a super-pressurised medium. From Table 2 it can be seen that 41% of the total mass of nitrogen dissolves into FM200 while 35% of the total mass of nitrogen dissolves into Novec 1230, at a temperature of 20° C. and a pressure of 60 bar(g)—the mass of nitrogen remaining in gaseous form and in the headspace above the liquid using water will not provide satisfactory operation because less the 0.15% of the total mass of nitrogen will dissolve into the water.

When the releasing member 17 opens, and the gas which was dissolved in the fire extinguishing agent prior to activation rapidly expands. This rapid expansion of gas dissolved within the fire extinguishing agent causes an increase in the turbulence level within the canister 13, and leads to the creation of a two phase mixture of liquid and gas which fills the interior volume 15 of the canister 13. While in the two-phase state, virtually all the fire extinguishing agent is discharged from the interior volume 15 of the canister 13, through the releasing member 17 and into the crew bay of the vehicle.

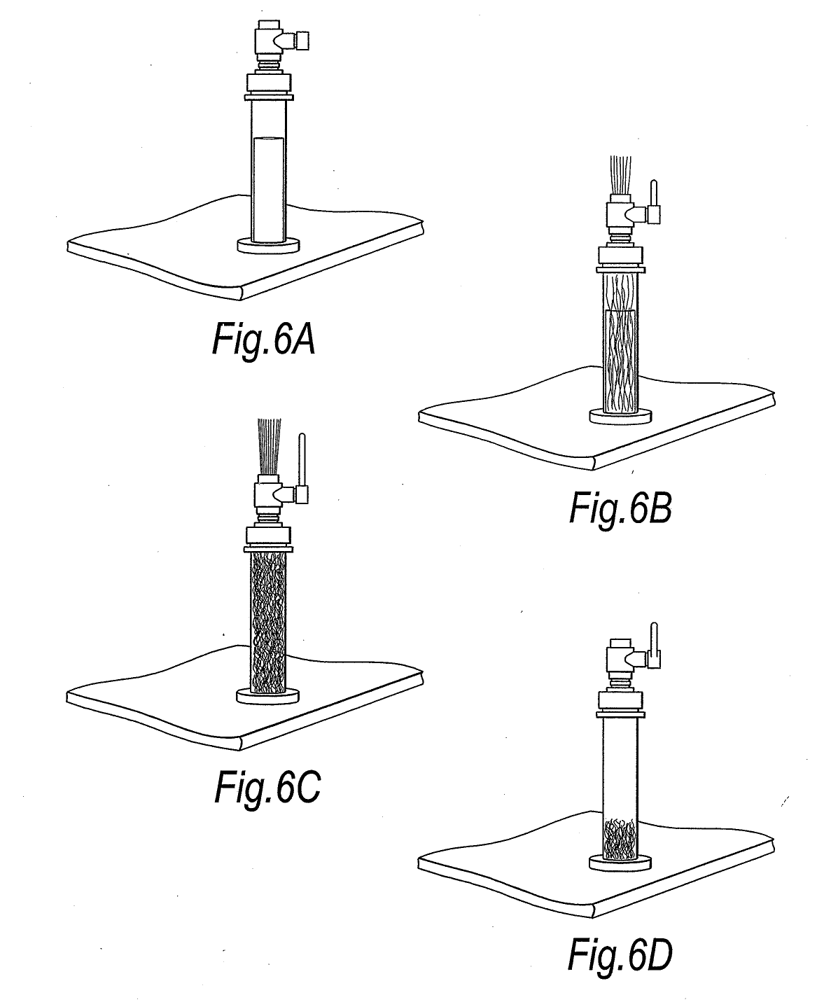

FIGS. 6A to 6D show this phenomenon. FIG. 6A shows a transparent pamasol assembly filled with 60 millilitres of FM200 and pressurised to 10 bar(g) with nitrogen. The figures show what happens when the container is rapidly discharged via a manual quarter inch (6.4 millimetre) ball valve (which is the release mechanism in this example). FIG. 6A shows the assembly prior to discharge (time=0 seconds). FIG. 6B shows the early stages of discharge between 0 and 0.1 seconds. FIG. 6C shows the assembly during discharge between 0.1 and 2 seconds. Fluid can be seen being emitted from the ball valve. FIG. 6D shows the assembly towards the end of the discharge after 2 seconds.

It can be seen that in FIG. 6C the liquid froths up within the vessel to form a two-phase mixture of liquid and gas which completely fills the volume of the container. Whilst in this state virtually all the liquid and gas portion of the extinguishing agent exits the outlet orifice of the ball valve. The dissolution of nitrogen from the extinguishing agent is a dynamic event, which begins very violently but as the pressure differential decays, slows down until eventually it stops completely. FIG. 6C demonstrates that the liquid FM200 extinguishant can discharge vertically upwards through a ball valve located at the top of the assembly when the nitrogen dissolved within the liquid is still rapidly coming out of solution. Prior to the present invention, the assumption by those skilled in the art was that a top mounted outlet would not discharge the liquid extinguishant but would simply allow the pressurising nitrogen gas to escape while leaving most or a significant proportion of the liquid extinguishant within the container.

Because, in the embodiments, the primary or principal mechanism for discharging the extinguishant is that of rapid nitrogen dissolution, the apparatus 11 should be arranged such that the vessel is emptied of most or substantially all of the extinguishant before nitrogen dissolution ends or is reduced to an insignificant amount.

Tests were conducted on prototypical apparatus mounted horizontally, at 32° tilt and 17° roll, and mounted vertically. The apparatus was pressurised to 60 bar. These tests showed the amount of fire extinguishing agent remaining after discharge to be 0.06%, 0.6% and 2.2% of the initial fill mass respectively. Substantial discharge will occur irrespective of the location of the releasing member 17 along the length of the canister 13.

Explosion suppression tests have been conducted in an arrangement similar to that used in a military ground vehicle application. Tests were initially carried out on known apparatus (comprising a solenoid actuator), and tests on prototypical apparatus in accordance with the present invention were subsequently compared to these results. The canister pressure was lowered (to simulate cold discharge conditions) and the mounting arrangements of the canisters adjusted (to simulate a ground vehicle travelling at extremes of tilt and roll) to test the performance of the prototypical canisters at these extremes of conditions. A summary of the results from the explosion suppression tests is shown in Table 3.

TABLE 3

| | | | | Explosion Suppression | |
|---|---|---|---|---|---|
| Apparatus Characteristics | | | | Results | |
| | | FM | | | Average |
| | | 200 | | Maximum | acid gas |
| | Mounting | Fill | Pressure | overpressure | HF levels |
| Apparatus | Arrangement | (kg) | (bar(g)) | (bar(g)) | (ppm) |
| 2 × known | vertical | 5.6 | 60 | 0.1 | >1000 |
| type | | | | | |
| 2 × known | vertical | 6.0 | 60 | 0.092 | >1000 |
| type | | | | | |
| 6 × prototype | Horizontal | 5.13 | 60 | 0.03 | 539 |
| 6 × prototype | Horizontal | 5.13 | 34.5 | 0.035 | 158 |
| 6 × prototype | Horizontal | 5.13 | 24.8 | 0.18 | 1253 |
| 6 × prototype | 32° tilt angle | 5.13 | 60 | 0.036 | 136 |
| 6 × prototype | 32° tilt angle, | 5.13 | 60 | 0.095 | 536 |
| | 17° roll | | | | |
| 6 × prototype | 32° tilt angle, | 5.13 | 47.6 | 0.09 | 330 |
| | 17° roll | | | | |

An unsuppressed explosion was generated within a FV432 vehicle and comprised 1 L of diesel fuel heated to 80° C. and pressurised to 4.1 bar(g), which when initiated, discharged into the vehicle via a spray bar. Following a 260 ms time delay, which allowed fuel to disperse within the vehicle, the explosion was initiated using 2×5 KJ pyrotechnic igniters.

When mounted horizontally the prototypical apparatus showed better fire suppression characteristics than known apparatus (overpressure within the crew bay is analogous to the intensity of the burning fire). An improvement in fire suppression occurs until the canister pressure is reduced below 34.5 bar(g)—which is well below 47.6 bar(g), the pressure corresponding to 60 bar(g) at the minimum design temperature of −20° C. The prototypical apparatus also shows improved fire suppression at a maximum tilt angle of 32°, when compared to the results of the known apparatus. A generally equivalent suppression performance is seen in the known apparatus with a vertical orientation and the prototypical apparatus at extremes of tilt and roll, both at the standard canister pressure of 60 bar(g) and at a canister pressure of 47.6 bar(g) which corresponds to a temperature of −32° C.

The rapid discharge and improved distribution characteristics of the prototypical apparatus is therefore seen to improve the suppression performance, in comparison to apparatus of known type, in most configurations—and at least match the performance of apparatus of known type in all other cases.

To further improve the performance of the apparatus, the releasing member 17 may advantageously include a container 21 (as shown in FIGS. 4 and 5) filled with a powder with good fire suppressing properties and preferably also acid gas scavenging properties. Acid scavenging is advantageous because acid gases such as hydrogen fluoride may be created as the fire is extinguished by the fire extinguishing agent, posing a further danger to the personnel within the crew bay of the vehicle. The term “powder” used hereinafter in the description refers to this type of powder, which is also referred to as Dry Chemical in the fire protection industry. The powder may be any suitable extinguishing agent (Dry Chemical). The powder may comprise alkaline metal salts, such as ammonium phosphate (MAP). By way of further example, the powder may comprise salts with sodium (Na) or potassium (K). One known type of extinguishing powder comprises sodium bicarbonate. The powder in the container 21 may be separated from the extinguishant and nitrogen in volume 15 by a paper or other frangible membrane 22. The membrane is broken when the valve is opened by pressure from the fluid in the volume 15.

FIGS. 4 and 5 show a container 21 located internally within the releasing member 17. The releasing member 17A of FIG. 8 also has such an internal powder container 21A. The container 21A has a membrane paper or other frangible material 22A (such as a polymeric film or foam), which prevents the powder from moving within the interior volume 15 of the tubular canister 13, but allows some liquid extinguishant and nitrogen (or other pressurising fluid) to fill the interstitial gaps between the powder particles (i.e. the container 21A is at the same pressure as the rest of the apparatus 11). On actuation of the valve 30A the membrane 22A is ruptured due to the high pressure differential at the releasing member 17A and the powder is discharged at the very early stages of the extinguishing process.

The powder should not preferably be stored within the interior volume 15 of the tubular canister 13 because the powder discharge would not necessarily then occur in a repeatable, predictable and controllable way and would not contribute to fire suppression or acid scavenging as early as in the preferred embodiment, resulting in reduced effectiveness. For example, if the vehicle in which the apparatus 11 were mounted was in a condition of significant tilt or roll, this would tend to cause the powder to accumulate at a particular location within the interior volume 15, from where it is unlikely that the powder would be discharged at an appropriate time within the extinguishing procedure. Indeed, all or a portion of the powder may not be discharged at all during the extinguishing procedure.

Releasing member 17B has an alternative arrangement of container 21B. The container 21B is mounted just outside the valve 30B. The container 21B preferably is provided with a membrane 22B or the like that is strong enough to prevent the ingress of water or debris during storage, but weak enough to rupture easily following actuation of the valve 30B. It is possible that the container 21B may itself be pressurised separately from the tubular canister 13 but must rupture following the actuation of the release member.

Releasing member 17C does not contain the powder container 21C. Instead, the powder container 21C is mounted separately from the canister 13. The container 21C is arranged so that the powder therein is released during actuation of the valve 30C by breaking the membrane 22C actively or via the Venturi effect.

The arrangement shown in FIG. 8 where the three different types of powder container 21A, 21B and 21C are shown provided for a single cylindrical container 13 is unlikely to be used in practice. Although more than one container 21 and releasing member 17 may be provided for a single cylindrical container 13, typically these will be of the same configuration (although, of course, this is not essential). FIG. 8 is primarily to illustrate the different arrangements of container 21 and releasing member 17 that are possible.

The discharge of a small portion of powder at the early stages of a fire extinguishing or suppressing process is well known to those skilled in the art of fire suppression of military crew compartments to significantly improve suppression performance, and may also reduce acid gas levels. Table 4 (below) shows the effect of such powders. Tests were carried out to demonstrate the effect of adding powder suppressants in different quantities, at different times during the discharge and using the different powder container arrangements 21A,21B and 21C described above. The results shown in Table 4 show the effect of powder suppressant arrangements on a conventional apparatus, such as shown in FIGS. 1 and 1A, but comparable effects will be obtained if applied to apparatus 11 of the embodiments. Table 4 clearly shows that adding a small portion of powder (around 5 wt % of the agent) greatly improves the efficiency of the fluid extinguishing agent alone. Adding more than 5 wt % of powder gave little additional benefit. The separately mounted container 21C discharges powder more evenly throughout the discharge. The results indicate that this was less effective than discharging all the powder into the vehicle crew compartment at the early stages of the discharge as achieved when using the internal container 21A and external container 21B arrangements.

TABLE 4

| | | | | Explosion Suppression | |
|---|---|---|---|---|---|
| Apparatus Characteristics | | | | Results | |
| | FM200 | Powder | | Maximum | Average |
| | Fill | Fill | | overpressure | acid gas HF |
| Apparatus | (Vol %) | (wt %) | Storage | (bar(g)) | levels (ppm) |
| 2 × known | 10 | nil | | 1.24 | 8200 |
| type | | | | | |
| 2 × known | 10 | 5 | Container | 0.32 | 280 |
| type | | | 21A | | |
| 2 × known | 10 | 5 | Container | 0.3 | 300 |
| type | | | 21B | | |
| 2 × known | 10 | 5 | Container | 0.55 | 750 |
| type | | | 21C | | |

It is preferable that the container 21 is activated simultaneously with (or fractionally before) the discharge of the fluid fire extinguishing agent within the interior volume 15. Advantageously, as the apparatus 11 is activated, the powder suppressant is discharged from the container 21 ahead of the fluid fire extinguishing agent to act to suppress the fire prior to the fire being extinguished by the fluid fire extinguishing agent. After the fire has been extinguished by the fluid fire extinguishing agent and the powder, the powder may then neutralise the acid gas created by the fluid fire extinguishing agent to promote a safe level within the crew bay. The mass of powder may be between 1% and 2%, and more preferably between 2% and 15% and most preferably 5% by weight of the fluid fire extinguishant agent.

As discussed above, the extinguishant will come out of the canister 13 as long as the dissolution of gas from the extinguishing fluid is still occurring rapidly enough. Longer canisters 13 and smaller diameter canisters 13 will tend to increase the amount of turbulence required to achieve a complete discharge of extinguishing agent.

The shape of the canister 13 is therefore a consideration when designing fire extinguishing apparatus in accordance with the invention.

The embodiments described herein are not intended to—and should not be taken to—limit the scope of the protection sought in this application, which is properly defined by the following claims. In particular, any suitable configuration of the apparatus and canister, any suitable fire extinguishing agent, and any suitable fire suppressing and acid gas scavenging powder could be used.

Although the embodiments hereinbefore described relate to military brand vehicle crew bays, it should be understood that the invention is also suitable for other applications. The invention is suitable for fire suppression in any chamber or enclosed volume.

For example, the invention may be applied to engine compartments for commercial buses, boats/ships, and military vehicles, and also military aircraft dry bays. These applications would typically not include the fire suppressing and/or acid gas scavenging powder (and the associated apparatus). Such a powder may advantageously be used when the invention is applied to an aircraft crew rest compartment or the like.

1. Fire extinguishing or suppressing apparatus comprising;
an elongate vessel having a wall defining an interior volume and a longitudinal axis, the vessel extending from a first end to a second end along the longitudinal axis, and a vessel outlet extending through the wall to an exterior of the elongate vessel at a location between the first end and the second end, the vessel containing within the interior volume a fire extinguishing agent and nitrogen, stored under pressure, wherein the fire extinguishing agent is super-pressurised by the nitrogen at a pressure of 34.5 bar(g) or more, wherein the longitudinal axis of the vessel is horizontally orientated;
means for selectively discharging the fire extinguishing agent by opening the outlet in the vessel, wherein opening the outlet causes the formation of a transient two-phase mixture of the nitrogen and the fire extinguishing agent in the vessel and rapid expansion of the nitrogen, the formation of a transient two-phase mixture in the vessel being a primary mechanism for discharging the fire extinguishing agent from the vessel, and the outlet is sized to discharge substantially all of the fire extinguishing agent from the vessel while in the two-phase mixture; and
wherein the apparatus does not include a hose extending from the vessel outlet.

2. Apparatus according to claim 1, wherein a portion of the nitrogen is dissolved in the fire extinguishing agent.

3. Apparatus according to claim 1, in which the fire extinguishing agent comprises a halocarbon.

4. Apparatus according to claim 3, in which the fire extinguishing agent includes bromine, iodine or chlorine.

5. Apparatus according to claim 1, in which the fire extinguishing agent comprises a hydrofluorocarbon.

6. Apparatus according to claim 5, in which the fire extinguishing agent is FM200 (RTM) and/or FE36 (RTM).

7. Apparatus according to claim 1, in which the fire extinguishing agent comprises a perfluoroketone.

8. Apparatus according to claim 5, in which the fire extinguishing agent is Novec (RTM) 1230.

9. Apparatus according to claim 1, wherein the discharging means comprises a valve assembly.

10. The apparatus of claim 9, wherein the valve assembly is responsive to a signal indicating the occurrence of an incident requiring fire extinguishing or suppressing.

11. The apparatus of claim 10, including detection means for detecting the incident.

12. Apparatus according to claim 11, wherein the detection means includes an infra-red sensor and/or ultra-violet.

13. Apparatus according to claim 9, wherein the discharging means comprises a plurality of valve assemblies.

14. Apparatus according to claim 9, in which the valve assembly or valve assemblies has or have a low profile with respect to the vessel.

15. Apparatus according to claim 1, including a chamber for containing a fire extinguishing, fire suppressing and/or acid scavenging powder.

16. Apparatus according to claim 15, in which the chamber has a barrier or membrane which, in use, is ruptured or broken as the fire extinguishing agent is discharged from the vessel such that the powder is discharged from the chamber.

17. The apparatus of claim 16, wherein the barrier or membrane comprises paper, polymeric film, or foam.

18. The apparatus of claim 15, wherein the chamber is located between the fire extinguishing agent and the outlet.

19. The apparatus of claim 15, in which the powder is sodium bicarbonate or other alkaline metal salts.

20. The apparatus of claim 15, in which the mass of powder is between 1% and 20% by weight of the fire extinguishing agent.

21. The apparatus of claim 15, in which the mass of powder is between 2% and 10% by weight of the fire extinguishing agent.

22. The apparatus of claim 15, in which the mass of powder is 5% by weight of the fire extinguishing agent.

23. Apparatus for deploying a fire extinguishing, fire suppressing or acid scavenging powder for use with a fire extinguishing or suppressing device which discharges a fire extinguishing or suppressing agent in response to detection of an incident, the apparatus including a vessel in which said powder is stored and having a barrier or membrane which, in use, is ruptured or broken as the fire extinguishing agent is discharged from the device such that the powder is discharged from the vessel, wherein a mass of the powder is between 1% and 20% by weight of the fire extinguishing agent, wherein the fire extinguishing or suppressant device is as claimed in claim 1.

24. An apparatus for deploying a fire extinguishing, fire suppressing or acid scavenging powder for use with a fire extinguishing or suppressing device which discharges a fire extinguishing or suppressing agent in response to detection of an incident, the apparatus including a vessel in which said powder is stored and having a barrier or membrane which, in use, is ruptured or broken as the fire extinguishing agent is discharged from the device such that the powder is discharged from the vessel, wherein the fire extinguishing or suppressant device is as claimed in claim 1.

25. The apparatus of claim 23, wherein the barrier or membrane comprises paper polymeric film, or foam.

26. The apparatus of claim 23, wherein the vessel is located between the fire extinguishing agent and an outlet therefore.

27. The apparatus of claim 23, in which the powder includes alkaline metal salts.

28. The apparatus of claim 23, in which the mass of powder is between 2% and 10% by weight of the fire extinguishing agent.

29. The apparatus of claim 23, in which the mass of powder is 5% by weight of the fire extinguishing agent.

30. The apparatus of claim 24, wherein the barrier or membrane comprises paper polymeric film, or foam.

31. Apparatus according to claim 1, wherein the vessel has a length extending along the longitudinal axis from the first end to the second end, and a width extending perpendicular to the transverse axis, wherein the length is greater than the width.

32. Fire extinguishing or suppressing apparatus comprising:
an elongate vessel having a wall defining an interior volume and a longitudinal axis, the vessel extending from a first end and a second end along the longitudinal axis, and a vessel outlet extending through the wall to an exterior of the elongate vessel at a location between the first end and the second end, the vessel containing within the interior volume a fire extinguishing agent and nitrogen, stored under pressure, and the vessel is super-pressurised by the nitrogen at a pressure of 34.5 bar(g) or more and a portion of the nitrogen is dissolved in the fire extinguishing agent, and wherein the longitudinal axis of the vessel is horizontally orientated;
a discharge mechanism configured to selectively open the outlet of said vessel to discharge the fire extinguishing agent, wherein opening the outlet causes the dissolution of the nitrogen from the fire extinguishing agent and the formation of a transient two-phase mixture of the nitrogen and the fire extinguishing agent in the vessel, the formation of a transient two-phase mixture in the vessel being a primary mechanism for discharging the fire extinguishing agent from the vessel, and the outlet is sized to discharge substantially all of the fire extinguishing agent from the vessel while in the two-phase mixture; and
wherein the apparatus does not include a hose extending from the vessel outlet.

33. The apparatus of claim 32, wherein the dissolution of the fluid causes the formation of the two-phase mixture in the vessel.

34. Apparatus according to claim 32, in which the fire extinguishing agent comprises a halocarbon.

35. Apparatus according to claim 33, in which the fire extinguishing agent includes bromine, iodine or chlorine.

36. Apparatus according to claim 32, in which the fire extinguishing agent comprises a hydrofluorocarbon.

37. Apparatus according to claim 36, in which the fire extinguishing agent is FM200 (RTM) and/or FE36 (RTM).

38. Apparatus according to claim 32, in which the fire extinguishing agent comprises a perfluoroketone.

39. Apparatus according to claim 38, in which the fire extinguishing agent is Novec (RTM) 1230.

40. Apparatus according to claim 32, wherein the discharging means comprises a valve assembly.

41. The apparatus of claim 40, wherein the valve assembly is responsive to a signal indicating the occurrence of an incident requiring fire extinguishing or suppressing.

42. The apparatus of claim 41, including detection means for detecting the incident.

43. Apparatus according to claim 38, wherein the detection means includes an infra-red sensor and/or ultra-violet sensor.

44. Apparatus according to claim 36, wherein the discharging means comprises a plurality of valve assemblies.

45. Apparatus according to claim 36, in which the valve assembly or valve assemblies has or have a low profile with respect to the canister.

46. Apparatus according to claim 32, wherein the fire extinguishing agent is super-pressurised by the fluid.

47. Apparatus according to claim 32, including a chamber for containing a fire extinguishing, fire suppressing and/or acid scavenging powder.

48. An apparatus for deploying a fire extinguishing, fire suppressing or acid scavenging powder for use with a fire extinguishing or suppressing device which discharges a fire extinguishing or suppressing agent in response to detection of an incident, the apparatus including a vessel in which said powder is stored and having a barrier or membrane which, in use, is ruptured or broken as the fire extinguishing agent is discharged from the device such that the powder is discharged from the vessel, wherein the fire extinguishing or suppressant device is as claimed in claim 32.

49. Apparatus according to claim 32, wherein the vessel has a length extending along the longitudinal axis from the first end to the second end, and a width extending perpendicular to the transverse axis, wherein the length is greater than the width.

50. Fire extinguishing or suppressing apparatus comprising;
an elongate vessel having a wall defining an interior volume and a longitudinal axis, the vessel extending from a first end to a second end along the longitudinal axis, and a vessel outlet extending through the wall to an exterior of the elongate vessel at a location between the first end and the second end, the vessel containing within the interior volume a fire extinguishing agent and nitrogen, stored under pressure, wherein the fire extinguishing agent is super-pressurised by the nitrogen at a pressure of 34.5 bar(g) or more, wherein the longitudinal axis of the vessel is horizontally orientated;
means for selectively discharging the fire extinguishing agent by opening the outlet in the vessel, wherein opening the outlet causes the formation of a transient two-phase mixture of the nitrogen and the fire extinguishing agent in the vessel and rapid expansion of the nitrogen, the formation of a transient two-phase mixture in the vessel being a primary mechanism for discharging the fire extinguishing agent from the vessel, and the outlet is sized to discharge substantially all of the fire extinguishing agent from the vessel while in the two-phase mixture; and
wherein the vessel outlet is provided in a bottom half of the elongate vessel.
